(19) United States
(12) Patent Application Publication
(10) Pub. No.: US 2025/0219711 A1
(43) Pub. Date: Jul. 3, 2025

(54) RELAY MANAGEMENT

(71) Applicant: Cisco Technology, Inc., San Jose, CA (US)

(72) Inventors: Matthew A. Silverman, Richardson, TX (US); Brian D. Hart, Sunnyvale, CA (US); Malcolm M. Smith, Richardson, TX (US); Binita Gupta, San Diego, CA (US)

(73) Assignee: Cisco Technology, Inc., San Jose, CA (US)

(21) Appl. No.: 18/668,317

(22) Filed: May 20, 2024

Related U.S. Application Data
(60) Provisional application No. 63/616,566, filed on Dec. 30, 2023.

(51) Int. Cl. H04B 7/15; H04W 76/15; H04W 88/04

(52) U.S. Cl. CPC H04B 7/15; H04W 76/15; H04W 88/04

(57) ABSTRACT

Relay management and specifically to encapsulated management and data frames and methods to create and delete relays may be provided. Relay management can include receiving a relay support announcement from a Relay Station (rSTA), the relay support announcement identifying a Transmitter STA (tSTA) the rSTA can provide relay support for. A relay request frame can be sent to the rSTA, the relay request frame indicating to establish a relay with the tSTA. A relay formation confirmation frame can be received from the rSTA to establish the relay.

### RELATED APPLICATION

Under provisions of 35 U.S.C. § 119 (e), Applicant claims the benefit of and priority to U.S. Provisional Application No. 63/616,566, filed Dec. 30, 2023, the disclosure of which is incorporated herein by reference in its entirety.

### TECHNICAL FIELD

The present disclosure relates generally to relay management and specifically to encapsulated management and data frames and methods to create and delete relays.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for relay management;

FIG. 2 is a block diagram of a first signal process for establishing a relay when a tSTA and a dSTA cannot directly communicate;

FIG. 3 is a block diagram of a second signal process for establishing a relay when the tSTA and the dSTA can directly communicate;

FIG. 4 is a block diagram of a third signal process for encapsulating relay data frames;

FIG. 5 is a flow chart of a method for relay management; and

FIG. 6 is a block diagram of a computing device.

### DETAILED DESCRIPTION

### Overview

Relay management and specifically to encapsulated management and data frames and methods to create and delete relays may be provided. Relay management can include receiving a relay support announcement from a Relay Station (rSTA), the relay support announcement identifying a Transmitter STA (tSTA) the rSTA can provide relay support for. A relay request frame can be sent to the rSTA, the relay request frame indicating to establish a relay with the tSTA. A relay formation confirmation frame can be received from the rSTA to establish the relay.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

In networking, a Station (STA), such as an Access Point (AP), may have weak zones or dead zones in its coverage area. The STA may use a relay to enable a sufficient connection in weak zones, dead zones, and/or areas beyond the STA's typical coverage area. To relay the transmission, the Transmitter STA (tSTA) may transmit to a Relay STA (rSTA), and the rSTA may relay the transmission to a Destination STA (dSTA). The rSTA may be positioned to provide a coverage area that extends beyond the tSTA's coverage area, such as where the dSTA is positioned, or otherwise have improved connections to the tSTA and the dSTA. For example, the Modulation and Coding Scheme (MCS) of the connection between the tSTA and the dSTA may be lower than the MCS between the rSTA and both the tSTA and the dSTA.

When the rSTA receives a frame, the rSTA may need to know the destination device (e.g., the dSTA, the tSTA, another STA) that the rSTA should relay the frame to. Otherwise, the rSTA may incorrectly determine the frame was sent to the rSTA as the final destination or incorrectly determine a different destination device. Data frames and management frames are described herein that identify the destination device with low overhead.

Additionally, methods are described herein for creating and deleting relays. The methods may comprise simple and secure ways to establish a relay network involving a tSTA, a rSTA and a dSTA, for example when the tSTA is an AP, the rSTA is a relaying AP or non-AP STA, and the dSTA is a non-AP STA that directly connect to the tSTA or otherwise has a poor connection to the tSTA. rSTA discovery, relay establishment, relay deletion, and relay device authentication are described herein.

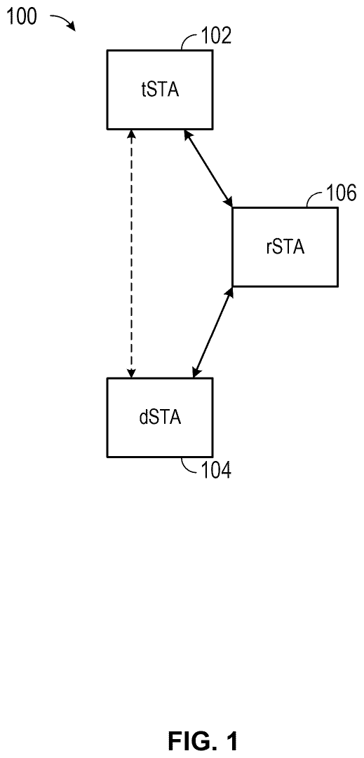

FIG. 1 is a block diagram of an operating environment 100 for relay management. The operating environment 100 may include a tSTA 102, a dSTA 104, and a rSTA 106. The tSTA 102 may be an AP that enables devices, such as the dSTA 104, to connect to a network. The dSTA 104 can be any device that connects to the network to communicate with other devices on the network, such as a smart phone, a tablet, a personal computer, a server, and/or the like. The rSTA 106 may be any device (e.g., an AP, a non-AP STA) operable to relay transmissions between devices, such as the tSTA 102 and the dSTA 104.

Establishing a relay between the tSTA 102, the dSTA 104, and the rSTA 106 may be initiated by the tSTA 102 or the dSTA 104, The tSTA 102 or dSTA 104 may search for the rSTA 106 or another relay capable through which to establish a better connection between the tSTA 102 and the dSTA 104. Once the tSTA 102 or the dSTA 104 identifies a suitable relay device, such as the rSTA 106, the tSTA 102, the dSTA 104, and the rSTA 106 can establish a relay agreement.

Establishing a Relay when the tSTA 102 and the dSTA 104 Cannot Directly Communicate

When the dSTA 104 cannot directly communicate with the tSTA 102, the dSTA 104 may not be able to connect to another AP to access the wireless network. Therefore, the dSTA 104 may attempt to identify a relay device to connect to the tSTA 102. In some example implementations, the dSTA 104 may scan to identify if the dSTA 104 can connect to any APs before scanning for a relay device.

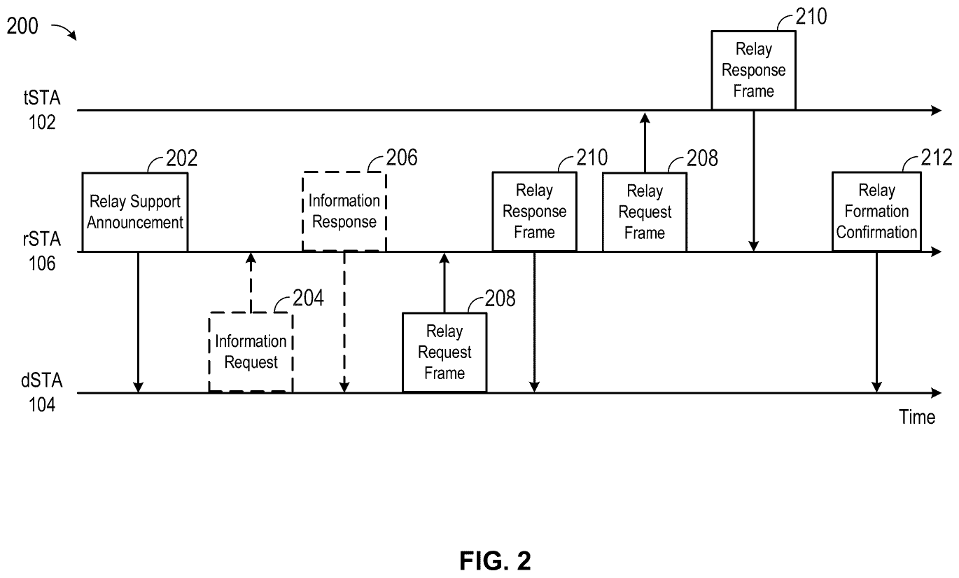

FIG. 2 is a block diagram of a first signal process 200 for establishing a relay when a tSTA and a dSTA cannot directly communicate. In some embodiments, relay capable devices or relay dedicated devices, such as the rSTA 106, may intermittently transmit or otherwise advertise a relay support announcement 202. In other embodiments, the rSTA 106 may transmit the relay support announcement 202 in response to a request from the dSTA 104 to use the rSTA 106 to relay communications. The relay support announcement 202 may be a beacon, a Neighbor Discovery protocol (NDP) frame, and/or the like. In example implementations, a relay capable device, such as the rSTA 106, may only transmit the relay support announcement 202 when the relay capable device is either an AP or already associated to an AP, such as the tSTA 102.

In certain embodiments, the relay support announcement 202 Information Element (IE) can include an indication of the relay device type (i.e., AP, non-AP STA), and the relay support announcement 202 IE can include the identity (e.g., Media Access Control (MAC) address, AP Multi-Link Device (MLD) MAC address) of one or more APs the rSTA 106 can provide relay support for, including the tSTA 102 for example. If the rSTA 106 is a non-AP STA, the relay support announcement 202 IE can include a quality indicator (e.g. a Received Signal Strength Indicator (RSSI)) of the current connection the rSTA 106 has with the AP the rSTA 106 is associated with. If the rSTA 106 is a non-AP MLD, the relay support announcement 202 IE can include the number of links the rSTA 106 has setup with the AP the rSTA 106 is associated with, operating channel information for the links, channel load information for the links, and/or the like. Therefore, the dSTA 104 may use the relay support announcement 202 IE to identify APs, such as the tSTA 102, that have a strong enough connection with the rSTA 106 to communicate with via relay or confirm that the dSTA 104 can use the rSTA 106 for a target AP (e.g., the tSTA 102). The relay support announcement 202 IE can also indicate the security applied for the connection of the rSTA 106 to the AP the rSTA 106 is associated with (e.g. Institute of Electrical and Electronics Engineers (IEEE) 802.1x, Simultaneous Authentication of Equals (SAE), open, etc.). In some embodiments, the above information is included in multiple IEs of the relay support announcement 202. The dSTA 104 can use the relay support announcement 202 IE(s) to determine whether the dSTA 104 can use the rSTA 106 for securely relaying the traffic.

The dSTA 104 and the rSTA 106 may also use an advertising protocol (e.g., using the relay support announcement 202, using Access Network Query Protocol (ANQP)) for the dSTA 104 to request information from the rSTA 106. For example, the dSTA 104 may send an information request 204 including a request for a neighbor list of candidate APs capable of acting as a tSTA (e.g., advertising a relay support announcement 202), including the tSTA 102 for example, and respective quality indicator (e.g. RSSI) of each candidate AP. In example implementations, the rSTA 106 may discover candidate APs based on listening to the relay support announcement 202 IE in beacons, NDP, and the like to generate the list of candidate APs. The rSTA 106 can provide the information asked for in the information request 204 via an information response 206. The information response 206 can be a new relay support announcement 202 with the requested information included, an ANQP response frame with the requested information included, and/or the like.

The dSTA 104 may request information via the information request 204 about the capacity the rSTA 106 may provide the dSTA 104 (e.g., a value in Megabits per second (Mbps), a Quality-of-Service Basic Set Service (QBSS) load such as from an AP beacon, etc.). The capacity the rSTA 106 advertises, such as via the information response 206, may be assured with a Stream Classification Service (SCS) agreement in example implementations. The dSTA 104 may also query the rSTA 106 for duty cycle limits and/or other limitations of using the rSTA 106 as relay, timeout parameters, and/or the like via the information request 204. For instance, the rSTA 106 may be battery powered in some examples and determine to limit the resources consumed by the dSTA 104 when the rSTA 106 is used as a relay. The dSTA 104 use the information request 204 to query the rSTA 106 to receive any of the information described as part of the relay support announcement 202 IE and/or any of the information described as available for the dSTA 104 to query the rSTA 106 for may be part of the relay support announcement 202 IE.

The dSTA 104 may use any of the information described above to select the tSTA 102 to establish a relay with via the rSTA 106. The dSTA 104 may select the tSTA 102 because the information associated with the tSTA 102 and the rSTA 106 indicates the connection will operate sufficiently. In other examples, the dSTA 104 may identify the tSTA 102 as the best candidate AP to connect to. In a simplified process of relay creation, the dSTA 104 may hears the rSTA 106 and obtains information based on the relay support announcement 202 IE to select the tSTA 102 and the rSTA 106 for the relay. In an alternative process of relay creation, the dSTA 104 may scan for all candidate rSTAs in range of the dSTA 104 and may thereby obtain their relay support announcement 202 IEs. The dSTA 104 may also receive lists of the candidate APs of each rSTA and selects one rSTA and candidate AP by exchanging relay request frames 208 and relay response frames 210 with one or more of the candidate rSTAs and candidate APs. The relay request frames 208 and the relay response frames 210 can enable the dSTA 104 to establish a connection with the rSTA 106 and the tSTA 102.

In some embodiments, the relay request frames 208 and the relay response frames 210 include relay-specific IEs. The one or more IEs in the relay request frame 208 can include information in a typical probe request, information about the role of the requester (e.g., the dSTA 104 as a STA trying to connect to the network, the tSTA 102 as an AP enabling a connection to the network, or the rSTA 106 as a relay), general Quality of Service (QOS) requirements expected to use in a relay link (e.g., SCS requirements, Target Wait Time (TWT) requirements, Restricted TWT (rTWT) requirements, etc.), and/or the like. If the rSTA 106 is an AP and sending a relay request frame 208 to the dSTA 104, the rSTA 106 can optionally indicate a request to use a specific AP from the list of candidate APs provided in the relay support announcement 202. When the dSTA 104 is sending the relay request frame 208, the dSTA 104 can optionally indicate a request to use a specific AP from the list of candidate APs provided in the relay support announcement 202 and optionally indicate any specific link the dSTA 104 wants to use for the relay with the tSTA 102 if there are multiple links setup between the rSTA 106 and the tSTA 102. In some embodiments, the relay request frame 208 may be a probe request frame or an association request frame with any of the information described in one or more relay request frame 208 IEs.

The one or more IEs in the relay response frame 210 can include information in a typical probe response, information about the role of the requester, information about capacity the rSTA 106 may provide dSTA 104, an indication of acceptance or rejection of the relay setup proposed in the relay request frame 208, and/or the like. The relay response frame 210 may be a probe response frame or an association response frame with any of the information in on or more IEs. When the relay response frame 210 includes a rejection of the relay setup, the relay response frame 210 can include a modified proposal and/or a request to resubmit a relay request.

When the rSTA 106 sends a relay response frame 210 to the dSTA 104 including an acceptance of the relay setup, the relay response frame 210 can also include an indication that the rSTA 106 will confirm the relay setup with the tSTA 102. The rSTA 106 may send a relay request frame 208 to the tSTA 102 to request to set up the relay. The relay request frame 208 can contain any of the information described above, including an identification of the dSTA 104 (e.g., MAC address of the dSTA 104). The tSTA 102 can reply with a relay response frame 210 comprising any of the information described above, including an indication acceptance or rejection of the relay setup. If the tSTA 102 accepts the relay setup, then the tSTA 102, the dSTA 104, and the rSTA 106 can establish the relay. The rSTA 106 may send a relay formation confirmation frame 212 indicating the full establishment of the relay to the dSTA 104 when the tSTA 102 accepts the relay proposal and the relay is fully established. The dSTA 104 may then initiate association, authentication, and/or the like with the tSTA 102 via the relay.

Establishing a relay when the tSTA 102 and the dSTA 104 have a weak connection

When the tSTA 102 and the dSTA 104 can directly communicate but with a connection insufficient for normal operation or a connection poor enough for the tSTA 102 and/or the dSTA 104 to determine to use a relay for communicating, the tSTA 102 and/or the dSTA 104 can attempt to establish a relay. The tSTA 102 and/or the dSTA 104 may look at on and off channel relay capable devices and agree on one device to use (i.e., the rSTA 106) based on the device's availability, capabilities, and/or the like, the requirements of the relay link between the tSTA 102 and the dSTA 104, and/or the like. In an example implementation, one of the tSTA 102 and the dSTA 104 may identify the rSTA 106 and propose to use the rSTA 106 to the other device. The other device may accept or reject the rSTA 106. When the other device rejects the rSTA 106, one of the tSTA 102 and the dSTA 104 may identify another relay device to propose to the other device.

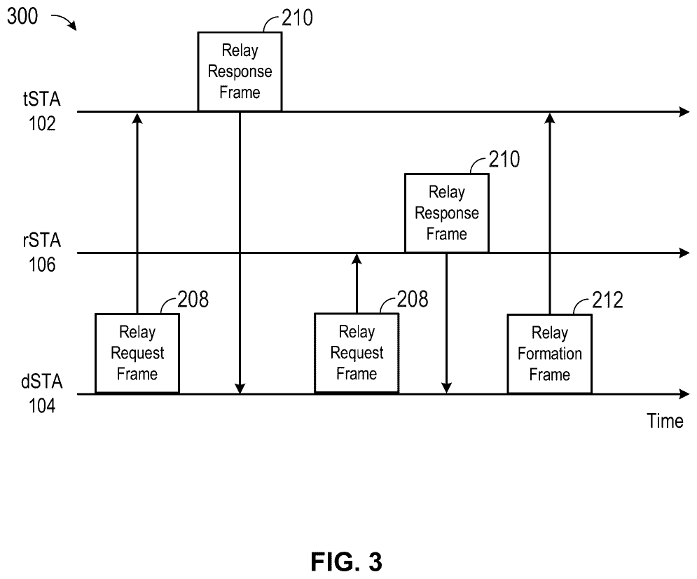

FIG. 3 is a block diagram of a second signal process 300 for establishing a relay when the tSTA and the dSTA can directly communicate. In the second signal process 300, the dSTA 104 can send a relay request frame 208 to the tSTA 102 that includes list of viable candidate relay devices from the perspective of the dSTA 104. The tSTA 102 can respond to the relay request frame 208 with a relay response frame 210. The relay response frame 210 in the second signal process 300 can include an acceptance indicating one of the relay devices from the list of candidate relay devices in the relay request frame 208, a rejection of the relay request, or a rejection with a request to retry relay establishment after a period.

In some embodiments, once the tSTA 102 sends the relay response frame 210 including an acceptance of the relay proposal using the rSTA 106, the dSTA 104 may send a relay request frame 208 to the rSTA 106. The relay request frame 208 may include the identity of the tSTA 102 and the dSTA 104 (e.g., MAC addresses) and other information associated with the proposed relay. The rSTA 106 may respond to the dSTA 104 with a relay response frame 210 including an acceptance, a rejection, or a rejection with a request to retry after a period. When the relay response frame 210 from the rSTA 106 includes an acceptance of the relay proposal, the dSTA 104 can send a relay formation confirmation frame 212 to the tSTA 102 to establish the relay. In other examples, the dSTA 104 may just begin using the rSTA 106 for communicating with the tSTA 102 rather than sending the relay formation confirmation frame 212 first. For example, ff the protocol of the second signal process 300 is defined such that the rSTA 106 receives a single relay request frame 208 from either the tSTA 102 or the dSTA 104 as illustrated, the dSTA 104 can send the relay formation confirmation frame 212 or a management frame to finalize the full establishment of the relay to tSTA 102. In other examples, the dSTA 104 and the tSTA 102 may both send relay request frames 208 to the rSTA 106 and both receive a relay response frame 210 from the rSTA 106. Thus, the relay will be established once the rSTA 106 sends the relay response frames 210 to the tSTA 102 and the dSTA 104.

The second signal process 300 depicts the dSTA 104 initiating the establishment of the relay; however, the tSTA 102 may initiate the establishment of the relay in other embodiments. Therefore, the tSTA 102 may perform the operations of the dSTA 104 in the second signal process 300, and the dSTA 104 may perform the operations of the tSTA 102 in the second signal process 300 in those embodiments. For example, the tSTA 102 may initiate the second signal process 300 by sending the relay request frame 208 to the dSTA 104 with a list of viable candidate relay devices, the dSTA 104 may respond with a relay response frame 210, the tSTA 102 can send the relay request frame 208 to the rSTA 106, the tSTA 102 can receive the relay response frame 210 from the rSTA 106, and/or the tSTA 102 can send the relay formation confirmation frame 212 to the dSTA 104. The neighbor list of relay capable devices from the tSTA 102 can include a list of candidate relay capable APs and a list of candidate relay capable non-AP devices.

In some embodiments, the rSTA 106 may be operating on a different channel than the tSTA 102 and the dSTA 104. Thus, the tSTA 102 and the dSTA 104 may agree to change their channel to the channel the rSTA 106 is operating on during the second signal process 300 or the first signal process 200. Determining to switch channels may be based on determining the characteristics of the rSTA 106 (e.g., capacity, connection quality, etc.) make the rSTA 106 a preferred device to use for the relay.

As described above, the dSTA 104 and/or the tSTA 102 can discover the rSTA 106 via a relay support announcement 202. The relay support announcement 202 can identify specific APs (e.g., via Basic Service Set Identifier (BSSID) or Service Set Identifier (SSID)) and/or STAs (e.g., via MAC address) reachable via relay. The rSTA 106 can send the relay support announcement 202 as a beacon to advertise the relay capability, but to avoid the excessive transmission of beacons, ANQP can be utilized for devices to query sets of proxied APs.

### Data Relay Frames and Management Relay Frames

Data relay frames and management relay frames may be implemented and used to enable the rSTA 106 to identify the destination of a transmission (e.g., the dSTA 104 can be the destination of a transmission from the tSTA 102, the tSTA 102 can be the destination of a transmission from the dSTA 104, etc.) and have a low overhead for the dSTA 104 and the rSTA 106. In some embodiments, a universal encapsulated frame is used for both data frames and management frames. In other embodiments, there may be encapsulated data frames used only for data frames only and encapsulated management frames used only for management frames. In yet other embodiments, an action frame with a new category and/or type can be used.

The universal encapsulated frame, the encapsulated data frame, the encapsulated management frame, and the action frame can all have frame formats that include a relay frame body. The relay frame body can include space (e.g., bits) for security fields and/or space for a Frame Check Sequence (FCS) field. When the security field and/or FCS field are unspecified or otherwise not used (e.g., no bits assigned to the security field and/or the FCS field) on a transmission, the security field and/or FCS field may be ignored and overwritten when the frame is received.

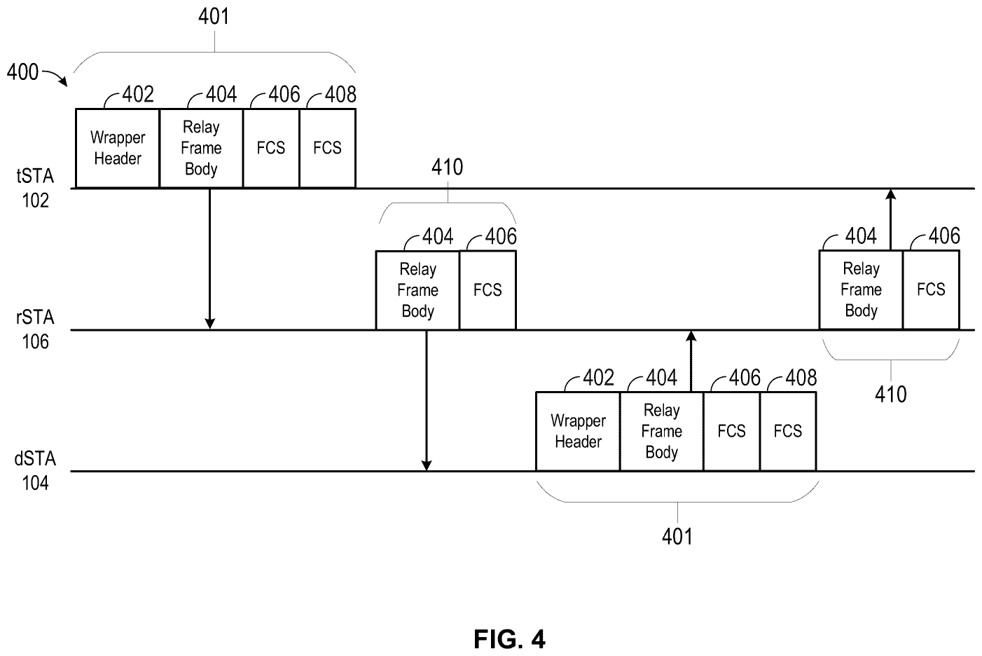

FIG. 4 is a block diagram of a third signal process 400 for encapsulating relay data frames. The third signal process 400 can include the transmission of any of an encapsulated frame 401. The encapsulated frame 401 may be any one of the universal encapsulated frame, the encapsulated data frame, the encapsulated management frame, and the action frame. The encapsulated frame 401 can include a wrapper header 402, a relay frame body 404, a relay frame body FCS 406, and/or a wrapper FCS 408. When determining to transmit, the tSTA 102 and/or the dSTA 104 can prepare the relay frame body 404 for initial transmission to the rSTA 106. The relay frame body 404 may then be added or otherwise included in the encapsulated frame 401. The tSTA 102 and/or the dSTA 104 may then transmit the encapsulated frame 401, including the wrapper header 402, the relay frame body FCS 406, and/or the wrapper FCS 408. In some examples, the encapsulated frame 401 can be transmitted as an AMPDU Aggregated MAC Protocol Data Unit (AMPDU).

When the rSTA 106 receives the encapsulated frame 401 including the relay frame body 404, the rSTA 106 can identify the encapsulated frame 401 as including the relay frame body 404 based on the frame type and/or subtype values when the encapsulated frame 401 is one of universal encapsulated frame, the encapsulated data frame, or the encapsulated management frame, or the action frame category and/or type values when the encapsulated frame 401 is the action frame. The rSTA 106 can then retrieve the relay frame body 404 from the encapsulated frame 401. In some embodiments, the rSTA 106 encrypts the relay frame body 404 and adds a relay frame body FCS 406 if needed to form a normal frame 410. The rSTA 106 may then send the normal frame 410 to the destination tSTA 102 or dSTA 104, for example based on the Receiver Address (RA) included in the frame.

In some embodiments, the relay frame body 404 may be associated with an IEEE 802.11k neighbor report request or response, or an IEEE 802.11v neighbor report request or response. The third signal process 400 for encapsulating the relay frame body 404 may therefore be used for relaying the IEEE 802.11k neighbor report request or response or the IEEE 802.11v neighbor report request or response. There may be protected and unprotected versions of the encapsulated frame 401. The wrapper header 402 for example may be protected through management protection. The relay frame body 404 for example may be protected the establishment of Protected Management Frame (PMF) protection via the relay.

### Deleting a Relay

Any of the tSTA 102, the dSTA 104, and the rSTA 106 may transmit a relay delete frame to delete or otherwise dissolve the relay. The relay delete frame can include a deletion reason field indicating the reason to delete relay (e.g. low battery, change in support for mode, too disruptive to non-relay links, determined a different, preferred relay configuration, etc.). Upon receiving a relay delete frame from any of the devices in the relay, the recipient device can a relay delete frame to the other relay device. For example, the rSTA 106 may receive the relay delete frame from the dSTA 104, and the rSTA 106 may send the relay delete frame to the tSTA 102 in response.

### Authentication and Security

For cases when the non-AP STA (e.g., the dSTA 104) is not already associated with the AP (e.g., the tSTA 102), there may be a security risk of the rSTA 106 simply proxying the traffic. Consequently, the relay setup may need to identify the end-point to the AP to allow full IEEE 802.1X authentication and provision the security stack on the relay in accordance with the AP (e.g. Robust Security Network (RSN), Authentication and Key Management (AKM), etc.) even if the link security is strictly between the rSTA 106 and the dSTA 104.

To prevent potential “man-in-the-middle” attacks via a rogue relay device, the dSTA 104 may validate that the rSTA 106 is relaying on behalf of the network or Extended Service Set (ESS). In some embodiments, the dSTA 104 must validate that the rSTA 106 is a member of the ESS prior to association. The ESS may be identified by a public/private key pair and a signature for the ESS/SSID. The public key for the ESS could be distributed to devices connected to the ESS on non-relay links or via an out of band mechanism. When a device associates to a relay device, the device can validate the relayed SSID that the relay is transmitting by verifying a signed ESS identifier delivered in the relay support announcement 202 IE. This can also be used as a mechanism for relay devices to validate other relay devices connected to the same ESS. In some embodiments, the dSTA 104 can also compare the signed ESS as part of the rSTA 106 scan list (e.g., received via the relay support announcement 202 IEs) to determine which relay devices are valid.

In some embodiments, after the relay formation confirmation, each relay device can register its identifier with the tSTA 102. The tSTA 102 can then append a tSTA 102 identifier to a list of valid relay device (e.g., relay devices that have been authenticated with the tSTA 102). The list of relay devices can be signed by the private key of the tSTA 102 and distributed as a signed relay neighbor list via the relay support announcement 202 or ANQP for example.

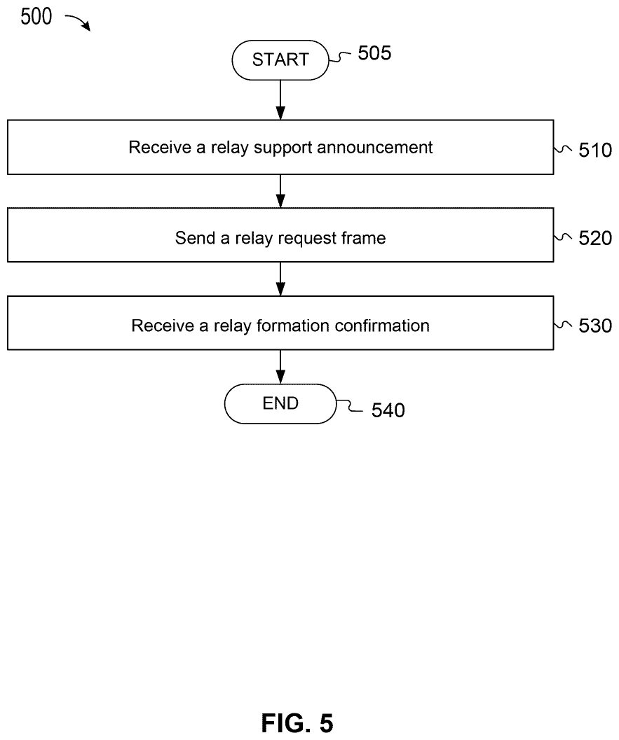

FIG. 5 is a flow chart of a method 500 for relay management. The method 500 can begin at starting block 505. In operation 510, a relay support announcement is received from a rSTA. For example, the dSTA 104 may receive the relay support announcement 202 from the rSTA 106. The relay support announcement 202 can identify the tSTA 102 that the rSTA 106 can provide relay support for. The relay support announcement 202 can include an indication of a device type of the rSTA 106, a list of candidate APs including the tSTA 102, a quality indicator of a connection between the rSTA 106 and the tSTA 102, security information for the connection between the rSTA 106 and the tSTA 102, and/or the like. In some embodiments, the dSTA 104 can send an information request 204 to request additional information or alternatively cause the rSTA 106 to send information, such as the relay support announcement 202. The rSTA 106 may respond with the information response 206.

In operation 520, a relay request frame is sent to the rSTA. For example, the dSTA 104 sends a relay request frame 208 to the rSTA 106. The relay request frame 208 can indicate to the rSTA 106 to establish a relay with the tSTA 102. The rSTA 106 may send a relay request frame 208 to the tSTA 102 to establish the relay.

In operation 530, a relay formation confirmation frame is received from the rSTA to establish the relay. For example, the dSTA 104 receives a relay formation confirmation frame 212 from the rSTA 106 to establish the relay with the tSTA 102. In some embodiments, any one of the tSTA 102, the dSTA 104, and the rSTA 106 may send a relay delete frame to delete the relay.

In certain embodiments, the dSTA 104 may validate the rSTA 106 is a part of an ESS before the relay is established. The dSTA 104 may prepare a relay frame body 404, create an encapsulated frame 401 including the relay frame body 404, and send the encapsulated frame 401 to the rSTA 106. The rSTA 106 is operable to retrieve the relay frame body 404 from the encapsulated frame 401 and send the relay frame body 404 to the tSTA 102 as a normal frame 410.

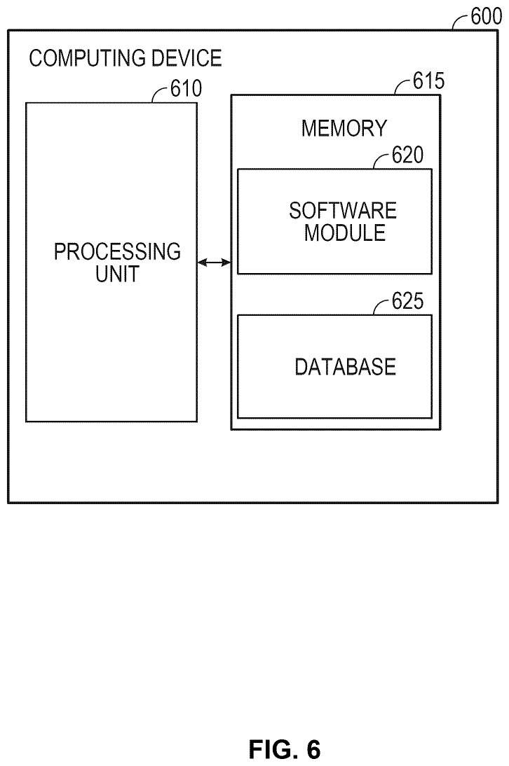

FIG. 6 is a block diagram of a computing device 600. As shown in FIG. 6, computing device 600 may include a processing unit 610 and a memory unit 615. Memory unit 615 may include a software module 620 and a database 625. While executing on processing unit 610, software module 620 may perform, for example, processes for relay management with respect to FIG. 1, FIG. 2, FIG. 3, FIG. 4, and FIG. 5. Computing device 600, for example, may provide an operating environment for the tSTA 102, the dSTA 104, the rSTA 106, and the like. The tSTA 102, the dSTA 104, the rSTA 106, and the like may operate in other environments and are not limited to computing device 600.

Computing device 600 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 600 may comprise any computer operating environment, such as hand-held devices, multiprocessor systems, microprocessor-based or programmable sender electronic devices, minicomputers, mainframe computers, and the like. Computing device 600 may also be practiced in distributed computing environments where tasks are performed by remote processing devices. The aforementioned systems and devices are examples, and computing device 600 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 600 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
receiving a relay support announcement from a Relay Station (rSTA), the relay support announcement identifying a Transmitter STA (tSTA) the rSTA can provide relay support for;
sending a relay request frame to the rSTA, the relay request frame indicating to establish a relay with the tSTA; and
receiving a relay formation confirmation frame from the rSTA to establish the relay.

2. The method of claim 1, wherein the relay support announcement comprises any one of: (i) an indication of a device type of the rSTA, (ii) a list of candidate Access Points (APs) including the tSTA, (iii) a quality indicator of a connection between the rSTA and the tSTA, (iv) security information for the connection between the rSTA and the tSTA, or (v) any combination of (i)-(iv).

3. The method of claim 1, further comprising:
sending an information request to the rSTA; and
receiving an information response from the rSTA.

4. The method of claim 1, further comprising:
sending a relay delete frame to any one of (i) the tSTA, (ii) the rSTA, or (iii) both (i) and (ii).

5. The method of claim 1, further comprising:
validating the rSTA is a part of an Extended Service Set (ESS) before the relay is established.

6. The method of claim 1, further comprising:
preparing a relay frame body;
creating an encapsulated frame by including the relay frame body in any one of (i) a universal encapsulated frame, (ii) an encapsulated data frame, (iii) an encapsulated management frame, or (iv) an action frame with a category and a type, wherein the encapsulated frame indicates the tSTA as a destination of the encapsulated frame; and
sending the encapsulated frame to the rSTA.

7. The method of claim 6, wherein the rSTA is operable to retrieve the relay frame body from the encapsulated frame and send the relay frame body to the tSTA as a normal frame.

8. A system comprising:
a memory storage; and
a processing unit coupled to the memory storage, wherein the processing unit is operative to:
receive a relay support announcement from a Relay Station (rSTA), the relay support announcement identifying a Transmitter STA (tSTA) the rSTA can provide relay support for;
send a relay request frame to the rSTA, the relay request frame indicating to establish a relay with the tSTA; and
receive a relay formation confirmation frame from the rSTA to establish the relay.

9. The system of claim 8, wherein the relay support announcement comprises any one of: (i) an indication of a device type of the rSTA, (ii) a list of candidate Access Points (APs) including the tSTA, (iii) a quality indicator of a connection between the rSTA and the tSTA, (iv) security information for the connection between the rSTA and the tSTA, or (v) any combination of (i)-(iv).

10. The system of claim 8, the processing unit being further operative to:
send an information request to the rSTA; and
receive an information response from the rSTA.

11. The system of claim 8, the processing unit being further operative to: sending a relay delete frame to any one of (i) the tSTA, (ii) the rSTA, or (iii) both (i) and (ii).

12. The system of claim 8, the processing unit being further operative to:
validate the rSTA is a part of an Extended Service Set (ESS) before the relay is established.

13. The system of claim 8, the processing unit being further operative to:
prepare a relay frame body;
create an encapsulated frame by including the relay frame body in any one of (i) a universal encapsulated frame, (ii) an encapsulated data frame, (iii) an encapsulated management frame, or (iv) an action frame with a category and a type, wherein the encapsulated frame indicates the tSTA as a destination of the encapsulated frame; and
send the encapsulated frame to the rSTA.

14. The system of claim 13, wherein the rSTA is operable to retrieve the relay frame body from the encapsulated frame and send the relay frame body to the tSTA as a normal frame.

15. A non-transitory computer-readable medium that stores a set of instructions which when executed perform a method executed by the set of instructions comprising:
receiving a relay support announcement from a Relay Station (rSTA), the relay support announcement identifying a Transmitter STA (tSTA) the rSTA can provide relay support for;
sending a relay request frame to the rSTA, the relay request frame indicating to establish a relay with the tSTA; and
receiving a relay formation confirmation frame from the rSTA to establish the relay.

16. The non-transitory computer-readable medium of claim 15, wherein the relay support announcement comprises any one of: (i) an indication of a device type of the rSTA, (ii) a list of candidate Access Points (APs) including the tSTA, (iii) a quality indicator of a connection between the rSTA and the tSTA, (iv) security information for the connection between the rSTA and the tSTA, or (v) any combination of (i)-(iv).

17. The non-transitory computer-readable medium of claim 15, the method executed by the set of instructions further comprising:
sending an information request to the rSTA; and
receiving an information response from the rSTA.

18. The non-transitory computer-readable medium of claim 15, the method executed by the set of instructions further comprising:
sending a relay delete frame to any one of (i) the tSTA, (ii) the rSTA, or (iii) both (i) and (ii).

19. The non-transitory computer-readable medium of claim 15, the method executed by the set of instructions further comprising:
validating the rSTA is a part of an Extended Service Set (ESS) before the relay is established.

20. The non-transitory computer-readable medium of claim 15, the method executed by the set of instructions further comprising:
preparing a relay frame body;
creating an encapsulated frame by including the relay frame body in any one of (i) a universal encapsulated frame, (ii) an encapsulated data frame, (iii) an encapsulated management frame, or (iv) an action frame with a category and a type, wherein the encapsulated frame indicates the tSTA as a destination of the encapsulated frame; and
sending the encapsulated frame to the rSTA.
